(19) United States
(12) Patent Application Publication
(10) Pub. No.: US 2005/0184428 A1
(43) Pub. Date: Aug. 25, 2005

(54) Continuous rubber-ribbon extruding system and a method employing the same

(76) Inventor: Masato Kitagawa, Osaka (JP)

Correspondence Address: JORDAN AND HAMBURG LLP, 122 EAST 42ND STREET, SUITE 4000, NEW YORK, NY, 10168, US

(21) Appl. No.: 10/786,803

(22) Filed: Feb. 25, 2004

(51) Int. Cl. B29C 47/50

(52) U.S. Cl. 264/211.23; 425/205

(57) ABSTRACT

A continuous rubber-ribbon extruding system includes at least a first continuous rubber extruding machine and a second continuous rubber-extruding machine. The first continuous rubber extruding machine includes: a first extruder for kneading and extruding a rubber material supplied thereto; a strainer for removing foreign substances from the rubber material supplied from the first extruder; and a first forming nozzle for extruding a rubber ribbon as a pre-process product. The second continuous rubber extruding machine includes: a second extruder supplied with the rubber ribbon as the pre-process product and operative to knead and extrude the rubber material; and a gear pump for delivering the rubber material, supplied from the second extruder, to a second forming nozzle which continuously extrudes a rubber ribbon to be used for building a tire.

### BACKGROUND OF THE INVENTION

1. Field of the Invention

The present invention relates to a continuous rubber-ribbon extruding system capable of continuously extruding a rubber ribbon to be used for building a tire, and to a method which employs the system.

2. Background Art

As a method for forming a rubber layer constituting a tread portion or side wall portion of a tire, there is known a process wherein a rubber ribbon having a predetermined sectional shape is fed onto a tire-building drum that is driven as rotated. A rubber layer having a predetermined profile is formed by winding the rubber ribbon on an outer periphery surface of the tire-building drum in a layer fashion as moving the rubber ribbon along a drum shaft (i.e. a rotary axis) of the tire-building drum.

Conventional continuous rubber extruding machines for continuously forming such a rubber ribbon include, for example, a high-precision rubber extruding system as disclosed in JP-5(1993)-116200A. As schematically shown in FIG. 2, a continuous rubber extruding machine employed by this system includes an extruder 100 for kneading and extruding a rubber material supplied thereto: a strainer 11 for removing foreign substances from the rubber material supplied from the extruder 100; and a gear pump 21 receiving the rubber material removed of the foreign substances by the strainer 11. A constant amount of rubber material is fed forward by the gear pump 21 while a rubber ribbon having a predetermined sectional shape is continuously extruded from a forming nozzle 102.

The strainer 11 is constituted by a metal mesh, honeycomb-shaped metal sheet or the like; see FIG. 3. When passed through the strainer 11, the rubber material encounters temperature increase due to passage resistance. The rubber material passed through the strainer 11 is fed to the gear pump. 21 which, in turn, delivers a constant amount of rubber material to the forming nozzle. In the gear pump 21, as well, the rubber material is also prone to be raised in temperature because the rubber material is subjected to compressive action. From the standpoint of maintaining the rubber material at an optimum process temperature, it is impracticable to increase the rotational speed of the gear pump 21. The reason is that the higher is the number of revolutions of the gear pump 21, the more raised is the temperature of the rubber material. Since the gear pump 21 cannot be increased in the number of revolutions thereof, it is impossible to increase the output of the rubber ribbon extruded from the forming nozzle 102. In consequence, the system cannot attain an increased productivity.

In view of the foregoing, it is intended to provide a continuous rubber-ribbon extruding system for continuously extruding a rubber ribbon for building a tire and a method employed by the system, the system permitting a gear pump to be increased in the number of revolutions as suppressing the temperature rise of the rubber material, thereby achieving an increased output of the rubber ribbon.

### SUMMARY OF THE INVENTION

According to the invention for solving the above problem, a continuous rubber-ribbon extruding system comprises at least a first continuous rubber extruding machine and a second continuous rubber-extruding machine. The first continuous rubber extruding machine comprises: a first extruder for kneading and extruding a rubber material supplied thereto; a strainer for removing foreign substances from the rubber material supplied from the first extruder; and a first forming nozzle for extruding a first rubber ribbon. The second continuous rubber extruding machine comprises: a second extruder for kneading and extruding the rubber material as supplied with the first rubber ribbon; and a gear pump for delivering the rubber material to a second forming nozzle as supplied with the rubber material from the second extruder, the second forming nozzle continuously extruding a second rubber ribbon used for building a tire.

The system of the above arrangement has the following advantageous effects and mechanism. Firstly, the system includes at least the first and second continuous rubber extruding machines. The first continuous rubber-extruding machine forms the first rubber ribbon, as a pre-processed rubber material. Specifically, the first extruding machine includes the first extruder, the strainer and the first forming nozzle. The first rubber ribbon extruded from the first forming nozzle may have a shape suited for being fed to the second continuous rubber-extruding machine performing the subsequent process. In the aforesaid pre-processing, the foreign substances are removed by the strainer.

The first rubber ribbon formed by the first continuous rubber-extruding machine is supplied to the second continuous rubber-extruding machine. The second continuous rubber-extruding machine includes the second extruder, the gear pump and the second forming nozzle but does not require the strainer. That is, the rubber material kneaded by the second extruder is supplied to the gear pump without being passed through the strainer. Hence, the rubber material at this stage does not encounter the temperature increase resulting from the passage through the strainer so that the gear pump may be increased in the number of revolutions. Accordingly, the output of the second rubber ribbon from the second forming nozzle can be increased. The second rubber ribbon extruded from the second forming nozzle is so shaped as to be suited for building a tire. Thus, with respect to the continuous rubber-ribbon extruding system for continuously extruding the rubber ribbon for building a tire; the system enables the gear pump to be increased in the number of revolutions as suppressing the temperature increase of the rubber material, thereby achieving an increased output of the rubber ribbon.

It is noted that the numbers of the first continuous rubber extruding machine and the second continuous rubber extruding machine to constitute the continuous rubber-ribbon extruding system are not limited to particular numerical values.

According to another preferred embodiment of the invention, the second continuous rubber-extruding machine may be disposed at place suited to supply the rubber ribbon directly to the tire-building drum.

Since the system is constituted by the first and second continuous rubber extruding machines which are separate from each other, the second continuous rubber-extruding machine may have a smaller size than the convention alone. Hence, the second continuous rubber extruding machine may be disposed at place as close as possible to the tire-building drum such as to be able to supply the rubber ribbon directly to the tire-building drum. Thus, the operation for winding the second rubber ribbon on the building drum can be performed efficiently.

According to the invention for solving the above problem, a continuous rubber-ribbon extruding method employs at least a first continuous rubber extruding machine and a second continuous rubber-extruding machine. A process performed by the first continuous rubber extruding machine includes: kneading and extruding a supplied rubber material by means of a first extruder: removing foreign substances from the rubber material by means of a strainer, the rubber material supplied from the first extruder; and forming a first rubber ribbon by extruding the rubber material from a first forming nozzle. A process performed by the second continuous rubber extruding machine and includes: receiving the first rubber ribbon and kneading and extruding the rubber material by means of a second extruder; delivering the rubber material to a second forming nozzle by means of a gear pump, the rubber material supplied from the second extruder; and continuously extruding a second rubber ribbon from the second forming nozzle the rubber ribbon used for building a tire.

The advantageous effects and mechanism of the arrangement are those mentioned supra.

### BRIEF DESCRIPTION OF THE DRAWINGS

FIG. 1 are diagrams showing a preferred embodiment of a continuous rubber-ribbon extruding system;

FIG. 2 is a diagram showing an arrangement of a continuous rubber forming machine according to the prior art; and

FIG. 3 are diagrams showing a construction of a strainer.

### DETAILED DESCRIPTION OF THE INVENTION

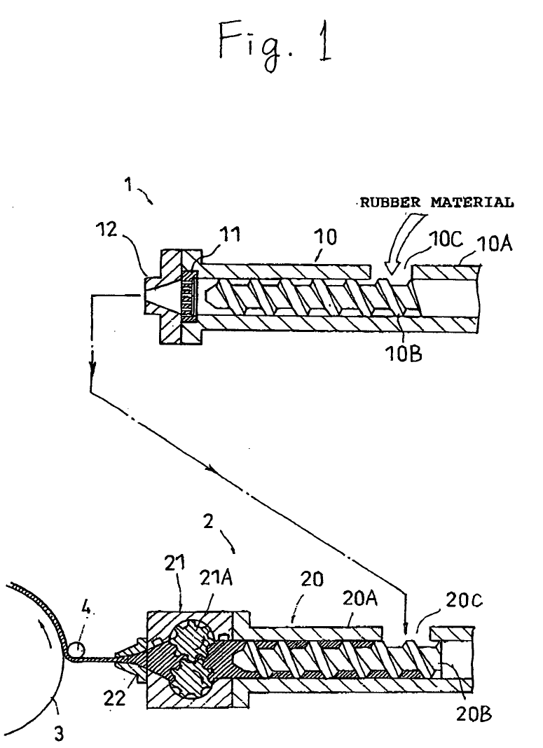

A continuous rubber-ribbon extruding system according to a preferred embodiment of the invention will be described with reference to the accompanying drawings. FIG. 1 is diagram showing a continuous rubber-extruding machine constituting the system.

<System Arrangement>

The system includes at least a first continuous rubber-extruding machine 1 (hereinafter, referred to as “first extruding machine”), and a second continuous rubber-extruding machine 2 (hereinafter, referred to as “second extruding machine”). As schematically shown in an upper portion of FIG. 1, the first extruding machine 1 includes a first extruder 10, a strainer 11 and a first forming nozzle 12. The first extruder 10 includes a barrel 10A having a cylindrical section, a screw 10B, and a feed port 10C through which a rubber material is fed into the extruder. Fed through the feed port 10C is a rubber material formed into a sheet form by the previous step of blending the rubber material. The screw 10B is rotated thereby kneading the rubber material and feeding the rubber material forwardly.

The strainer 11 is shown in FIG. 3. FIG. 3A is a sectional view of the strainer whereas FIG. 3B is a front view thereof. The strainer 11 includes a support body 11A and a metal mesh 11B fitted in the support body. The metal mesh 11B is formed with a plurality of fine pores 11C. The support body 11A is formed with a plurality of ribs 11D. The rubber material is fed from the right side of the drawing in FIG. 3A and passed through the strainer 11 to the left side. The rubber material may be removed of foreign substances by passing the material through the strainer 11.

A pre-processed rubber ribbon or a “first rubber ribbon” outputted from the first forming nozzle 12 has a sectional shape of a circle, square or rectangle. However, the sectional shape of the rubber ribbon is not particularly limited. The pre-processed rubber ribbon is supplied to the second extruding machine 2 to be described hereinafter and hence, may have any shape suited for the feeding purpose.

As schematically shown in a bottom portion of FIG. 1, the second extruding machine 2 includes a second extruder 20 of a smaller size, a gear pump 21 and a second forming nozzle 22. The second extruder 20 includes a barrel 20A having a cylindrical section, a screw 20B, and a feed port 20C. Fed through the feed port 20C is the rubber ribbon extruded from the first extruding machine 1 in the previous step. The screw 20b is rotated thereby kneading the rubber material and feeding forward the rubber material.

The rubber material is moved forward by the screw 20B so as to be supplied to the gear pump 21. Incidentally, it is unnecessary to provide a strainer because the foreign substances are already removed in the previous step. The gear pump 21 includes a pair of gears 21A drive-wise rotated for delivering a constant amount of rubber material to the second forming nozzle 22. The second forming nozzle 22 outputs a rubber ribbon or a “second rubber ribbon” having a predetermined sectional shape. The section of the rubber ribbon is shaped like a triangle, crescent or the like.

The rubber ribbon extruded from the second forming nozzle 22 is directly supplied to a tire-building drum 3 via a pressure roller 4. To wind the rubber ribbon on the tire-building drum 3, the second, extruding machine 2 may be moved axially of the tire-building drum 3 maintained in drivable rotation.

<Features of System Arrangement>

The system according the embodiment employs two types of extruding machines including the first and second extruding machines 1, 2 for extruding the rubber ribbons. The two extruding machines will be described.

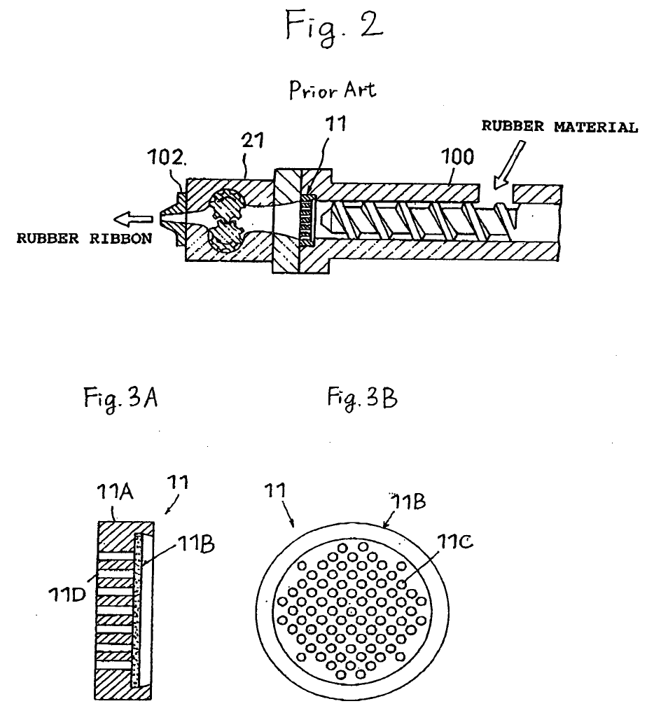

According to the conventional structure shown in FIG. 2 as described above, the rubber material produces heat due to the resistance associated with the passage through the strainer 11. There is known an optimum forming temperature for the extruding machine to form rubber. If the forming temperature is too high, a rubber ribbon of a desired quality cannot be obtained. When the rubber material through the strainer 11 is supplied to the gear pump, the rubber material will be further increased in temperature due to a compressive action of the gear pump. As the number of revolutions of the gear pump is increased, the rubber material is more prone to be raised in temperature. In order to prevent the temperature rise of the rubber material, the rotational speed of the gear pump must be limited. Therefore, the output of the rubber ribbon from the extruding machine must also be limited. This results in a decreased productivity.

On the other hand, the strainer 11 is constructed from the metal mesh 11B and the like. Where maintenance of the interior of the gear pump is performed, the maintenance requirements include a replacement of the metal mesh 11B and removal of the rubber material remaining in an internal passage of the gear pump through which the rubber material is passed. That is, when the gear pump is subjected to the maintenance work, the work also requires the strainer 11 to be replaced, thus resulting in a cumbersome job.

The metal mesh 11B must employ a fine mesh net such when to inhibit the passage of foreign particles in a minute dimensions. However, such fine mesh net is so poor in strength that the metal mesh 11B itself may be broken to produce a foreign substance. The resultant foreign substance involves a fear of damaging the gears in the gear pump, thus constituting a causative factor of a shortened service life of the gear pump.

According to the system arrangement shown in FIG. 1 there is no gear pump 21 disposed at direct downstream of the strainer 11. This obviates the problem that the gear pump 12 is damaged by the foreign substance. The gear pump 21 is disposed in the second extruding machine 2 and hence, the maintenance procedure for the gear pump 21 does not require the replacement of the strainer 11. Thus, the maintenance procedure for the gear pump 21 is improved in efficiency. In addition, the gear pump 21 is increased in the service life. Furthermore, if foreign substances should be included in the rubber ribbon outputted from the first extruding machine 1, a defective part of the rubber ribbon may be removed in this stage.

Since the second extruding machine 2 does not include the strainer 11, the machine does not encounter the temperature rise of the rubber material due to passing through the strainer 11. This permits the gear pump 21 to be increased in the number of revolutions. Thus, the output of the rubber ribbon may be increased so as to increase the productivity.

The first extruding machine 1 is provided for carrying out the pre-processing of the rubber material. A large machine may be used as the first extruding machine. On the other hand, the second extruding machine 2 can be downsized. This is because the rubber material is already kneaded in the pre-processing and because the second extruding machine need not be provided with the strainer 11.

<Operation>

A brief description will be made on an operation performed by the above system for continuously forming the rubber material. First, referring to FIG. 1, a sheet-shaped rubber material formed in the previous step is supplied via the feed port 10C. The rubber material is kneaded by the rotating screw 10B and fed forwardly. The kneaded rubber material is passed through the strainer 11, which removes the foreign substances which may be included therein. The rubber material through the strainer 11 is extruded from the first forming nozzle 12 as a rubber ribbon having a predetermined sectional shape.

The rubber ribbon extruded from the first extruding machine 1 may be immediately fed into the feed port 20c of the second extruding machine 2 or otherwise, temporarily stored at some other place before fed into the feed port 20c. The rubber material thus fed is kneaded again by the rotating screw 20b and fed forwardly. The gear pump 21 advances a constant amount of rubber material. Then, the rubber material is extruded from the second forming nozzle 22 as a rubber ribbon having a predetermined sectional shape.

The rubber ribbon outputted from the second extruding machine 2 is immediately wound on an outer periphery face of the tire-building drum 3 as guided by the pressure roller 4. In this manner, a desired rubber layer may be formed.

<Facility Arrangement>

Next, description will be made on an arrangement of a tire manufacturing facility employing the aforementioned continuous rubber-ribbon forming system. The tire manufacturing facility is provided with a plurality of processing stages. The second extruding machine 2 of the inventive system may be disposed at each of the stages for winding the rubber ribbon. At each of the stages, the rubber ribbon may be wound on the outer periphery of the tire-building drum by moving the second extruding machine 2 relative to the building drum.

As described in the foregoing, the second extruding machine 2 may be downsized because, the extruding machine is divided into the two types including the first extruding machine 1 and the second extruding machine 2. Hence, the mechanism for moving the second extruding machine 2 may also be downsized. On the other hand, the first extruding machine 1 used for the pre-processing may be constructed in a large size. Thus, the facility may be provided with a smaller number of first extruding machines 1, which are large in size whereas, a large number of second extruding machines 2, which are small in size, may be provided in correspondence to tire building stations.

<Modifications>

The specific arrangement of the continuous rubber forming system is not limited to the illustrative embodiment. In addition, the strainer is not limited to the illustrative example. In principle, the strainer may have a structure capable of removing the foreign substances.

1. A continuous rubber-ribbon extruding system comprising at least a first continuous rubber extruding machine and a second continuous rubber extruding machine,
said first continuous rubber extruding machine comprising: a first extruder for kneading and extruding a rubber material supplied thereto: a strainer for removing foreign substances from the rubber material supplied from the first extruder; and a first forming nozzle for extruding a first rubber ribbon,
said second continuous rubber extruding machine comprising: a second extruder for kneading and extruding the rubber material as supplied with said first rubber ribbon; and
a gear pump for delivering the rubber material to a second forming nozzle as supplied with the rubber material from the second extruder,
said second forming nozzle continuously extruding a second rubber ribbon to be used for building a tire.

2. A continuous rubber-ribbon extruding system as claimed in claim 1, wherein said second continuous rubber extruding machine is disposed as to supply the rubber ribbon directly to a tire-building drum.

3. A continuous rubber-ribbon extruding method employing at least a first continuous rubber extruding machine and a second continuous rubber extruding machine, and comprising: a process performed by said first continuous rubber extruding machine and including:
kneading and extruding a supplied rubber material by means of a first extruder;
removing foreign substances from the rubber material by means of a strainer, the rubber material supplied from the first extruder; and
forming a first rubber ribbon by extruding the rubber material from a first forming nozzle; and
a process performed by said second continuous rubber extruding machine and including:
receiving said first rubber ribbon and kneading and extruding the rubber material by means of a second extruder;
delivering the rubber material to a second forming nozzle by means of a gear pump, the rubber material supplied from the second extruder; and
continuously extruding a second rubber ribbon from said second forming nozzle, the second rubber ribbon being to be used for building a tire.
